(19) United States
(12) Patent Application Publication
(10) Pub. No.: US 2024/0187374 A1
(43) Pub. Date: Jun. 6, 2024

(54) METHOD AND APPARATUS FOR IMPROVING A SERVER DISCOVERY HANDLING PROCEDURE

(71) Applicant: LENOVO (BEIJING) LIMITED, BEIJING (CN)

(72) Inventor: TINGFANG TANG, BEIJING (CN)

(21) Appl. No.: 18/554,986

(22) PCT Filed: Apr. 11, 2021
(86) PCT No.: PCT/CN2021/086325

§ 371 Date: Oct. 11, 2023

(51) Int. Cl. H04L 61/4541; H04L 61/4511

(52) U.S. Cl. CPC H04L 61/4541; H04L 61/4511

(57) ABSTRACT

Embodiments of the present disclosure relate to methods and apparatuses for improving a server discovery handling procedure. According to an embodiment of the present disclosure, a method which may be performed at a network function of a network may include: receiving serving domain name service (DNS) information from a further network function of the network; and selecting a DNS server or an extension for DNS client subnet (ECS) option for a fully qualified domain name (FQDN) originating from a user equipment (UE), wherein the DNS server or the ECS option is selected based on: (a) the serving DNS information; and (b) at least one of: DNS configuration information of the network, and one or more rules for handling DNS information.

### TECHNICAL FIELD

Embodiments of the present disclosure are related to wireless communication technology, and more particularly, related to methods and apparatuses for improving a server discovery handling procedure.

### BACKGROUND

Wireless communication technologies have been developed to support edge computing in a 5G core network (5GC). In edge computing deployment, one application service might be served by multiple edge application servers (EAS) typically deployed in different sites. These multiple EAS instances that host the same content or service may use a single Internet protocol (IP) address (anycast address) or different IP addresses. A user equipment (UE) accesses an application server via a user plane function (UPF), which is used as a protocol data unit (PDU) session anchor (PSA), by a PDU session. The PDU session is established between the UE and the PSA UPF. One PDU session may support one or more applications. Before an user equipment (UE) starts to connect to the service, it is very important for the UE to discover an IP address of a suitable EAS (e.g., the one closest to the UE), so that the traffic can be locally routed between the UE and the EAS via uplink classifier or branching point (UL CL/BP) mechanisms or a PDU session established directly with the local data network (DN) where the EAS is deployed, and service latency, traffic routing path and user service experience can be optimized. Also, once a discovered EAS becomes non-optimized (e.g., after the UE moves far away), a new EAS may be discovered and used to replace the old one to serve the UE.

Thus, how to improve a server discovery handling procedure is an important issue to be resolved for edge computing.

### SUMMARY

According to some embodiments of the present disclosure, a method performed at a network function of a network may include: receiving serving domain name service (DNS) information from a further network function of the network; and selecting a DNS server or an extension for DNS client subnet (ECS) option for a fully qualified domain name (FQDN) originating from a UE, wherein the DNS server or the ECS option is selected based on: (a) the serving DNS information; and (b) “DNS configuration information of the network” and/or “one or more rules for handling DNS information”.

Some embodiments of the present application also provide a network function. The network function includes a processor and a wireless transceiver coupled to the processor; and the processor is configured: to receive, via the wireless transceiver, serving DNS information from a further network function of the network; and to select a DNS server or an ECS option for a FQDN originating from a UE the serving DNS information, wherein the DNS server or the ECS option is selected based on: (a) the serving DNS information; and (b) at least one of “DNS configuration information of the network” and “one or more rules for handling DNS information”.

According to further embodiments of the present disclosure, a method performed at a network function of a network may include: receiving DNS configuration information of the network; and transmitting: (a) serving DNS information; and (b) “the DNS configuration information of the network” and/or “one or more rules for handling DNS information”, so as to select a DNS server or an ECS option for a FQDN originating from a UE.

Some embodiments of the present application also provide a network function of a network. The network function includes a processor and a wireless transceiver coupled to the processor; and the processor is configured: to receive, via the wireless transceiver, DNS configuration information of the network; and to transmit, via the wireless transceiver, (a) serving DNS information; and (b) “the DNS configuration information of the network” and/or “one or more rules for handling DNS information”, so as to select a DNS server or an ECS option for a FQDN originating from a UE.

According to some other embodiments of the present disclosure, an apparatus may include: at least one non-transitory computer-readable medium having stored thereon computer executable instructions; at least one receiving circuitry; at least one transmitting circuitry; and at least one processor coupled to the at least one non-transitory computer-readable medium, the at least one receiving circuitry and the at least one transmitting circuitry. The computer executable instructions may cause the at least processor to implement a method according to any embodiment of the present disclosure.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1A illustrates an exemplary network architecture 100 supporting edge computing;

FIG. 1B illustrates an exemplary flow chart of a method for performing a server discovery handling procedure, in accordance with some embodiments of the present application;

FIG. 1C illustrates an exemplary flow chart of a method for transmitting serving DNS information, in accordance with some embodiments of the present application;

FIG. 2 illustrates a flow chart of an exemplary DNS configuration per node via SMF, in accordance with some embodiments of the present disclosure;

FIG. 3 illustrates a flow chart of an exemplary DNS configuration management procedure for providing DNS configuration information, in accordance with some embodiments of the present disclosure;

FIG. 4 illustrates a flow chart of two exemplary DNS configuration management procedures for receiving DNS configuration information, in accordance with some embodiments of the present disclosure;

FIG. 5 illustrates a further flow chart of an exemplary DNS configuration per node to EASDF, in accordance with some embodiments of the present disclosure;

FIG. 6 illustrates a further flow chart of two exemplary DNS configuration management procedures for receiving DNS configuration information, in accordance with some embodiments of the present disclosure;

FIG. 7 illustrates another flow chart of an exemplary DNS configuration per PDU session, in accordance with some embodiments of the present disclosure; and

FIG. 8 illustrates an exemplary block diagram of an apparatus according to some embodiments of the present application.

### DETAILED DESCRIPTION

The detailed description of the appended drawings is intended as a description of the currently preferred embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

In the following description, numerous specific details are provided, such as examples of programming, software modules, network transactions, database structures, hardware modules, hardware circuits, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference will now be made in detail to some embodiments of the present disclosure, examples of which are illustrated in the accompanying drawings. To facilitate understanding, embodiments are provided under specific network architecture and new service scenarios, such as 3rd Generation Partnership Project (3GPP) 5G, 3GPP Long Term Evolution (LTE) and so on. Persons skilled in the art know very well that, with the development of network architecture and new service scenarios, the embodiments in the present disclosure are also applicable to similar technical problems; and moreover, the terminologies recited in the present disclosure may change, which should not affect the principle of the present disclosure.

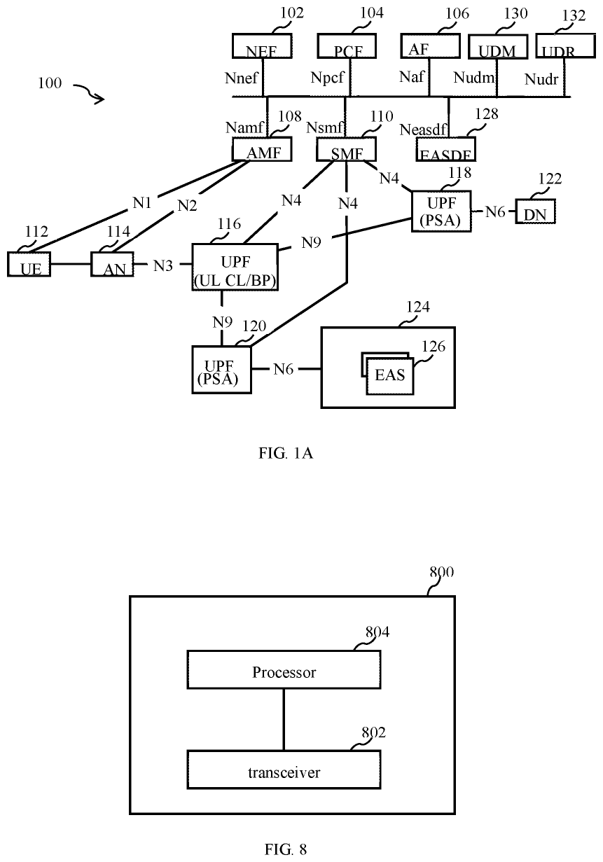

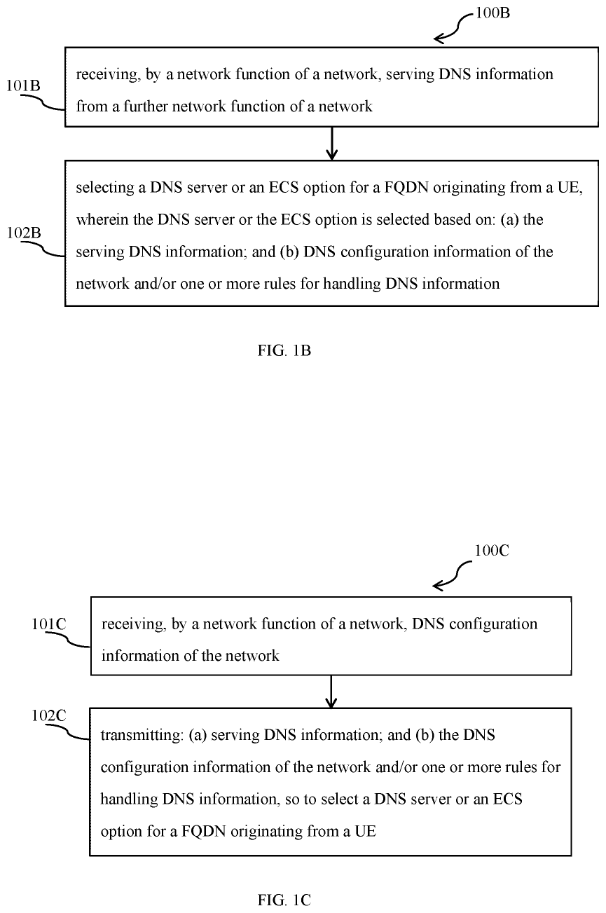

FIG. 1A illustrates an exemplary network architecture 100 supporting edge computing. The network architecture 100 includes several network functions (NFs), in which the techniques, processes and methods described herein can be implemented, in accordance with various embodiments. An NF may be implemented either as a network element on a dedicated hardware, as a software instance running on a dedicated hardware, or as a virtualized function instantiated on an appropriate platform, e.g., a cloud infrastructure. A single NF may be implemented by a single entity or multiple entities in conjunction.

Seen from the core network side, the network architecture 100 shown in FIG. 1A includes a network exposure function (NEF) 102, a policy control function (PCF) 104, an application function (AF) 106, an access and mobility management function (AMF) 108, a session management function (SMF) 110, an Edge Application Server Discovery Function (EASDF) 128, an Unified Data Repository (UDR) 132 and an Unified Data Management (UDM) 130. Nnef is a service-based interface exhibited by the NEF 102. Npcf is a service-based interface exhibited by the PCF 104. Naf is a service-based interface exhibited by the AF 106. Namf is a service-based interface exhibited by the AMF 108. Nsmf is a service-based interface exhibited by the SMF 110. Neasdf is a service-based interface exhibited by the EASDF 128. Nudm is a service-based interface exhibited by the UDM 130. Nudr is a service-based interface exhibited by the UDR 132.

Seen from the access side, the network architecture 100 shown in FIG. 1A includes a UE 112 connected to an access network (AN) 112 as well as to the AMF 108. Typically, the AN 112 includes one or more base stations, e.g., enhanced or evolved Node Bs (eNBs), 5G base stations (gNBs) or the like. The AN 112 may connect to a data network (DN) 122 via a user plane function (UPF) 116 and a UPF 118, and to a DN 124 via the UPF 116 and a UPF 120. A UPF to steer a traffic can be a UL CL or BP UPF (e.g., UPF 116) when there are multiple PSA UPFs (e.g., UPFs 118 and 120) for a PDU session. The UL CL or BP UPF can be a standalone UPF or be co-located with a PSA UPF. The UPF to steer a traffic can also be a PSA UPF or a UPF of N3 terminating point when there is only one PSA UPF for a PDU session (which means that there is no UL CL or BP UPF). The SMF 110 may make routing decisions for traffic of PDU sessions. For example, the SMF 110 may decide to select which of UPFs 118 and 120 as a PSA for traffic. The UE 112 communicates with the AMF 108 via an interface N1. The AN 114 communicates with the AMF 108 via an interface N2, and communicates with the UPF 116 via an interface N3. The UPFs 116, 118, and 120 communicate with the SMF 110 via an interface N4, respectively. The UPF 116 communicates with the UPFs 118 and 120 via an interface N9, respectively. The UPFs 118 and 120 communicate with the DNs 122 and 124 via an interface N6, respectively. Although only one UE and two DNs are depicted in FIG. 1A, it is contemplated that any number of UEs and DNs may be included in the network architecture 100. Further, the network architecture 100 may also include other components, for example, other NFs not shown in FIG. 1A.

In some embodiments of the present application, a UE may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, a UE may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some additional embodiments of the present application, a UE may include wearable devices, such as smart watches, fitness bands, optical head-mounted displays, or the like. Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art. As shown in FIG. 1A. one or more EAS 126 may be deployed in the DN 124. Other DNs (e.g., DN 122) may also include one or more EAS. In edge computing deployment, one application service might be served by multiple EAS typically deployed in different sites. These multiple EAS instances that host the same content or service may use a single IP address (anycast address) or different IP addresses. Before an application or a UE starts to connect to the service, it is very important for the application or the UE to discover the IP address of a suitable EAS (e.g., the one closest to the UE), so that the traffic can be locally routed to the EAS, and service latency, traffic routing path and user service experience can be optimized.

Generally, considering edge computing deployment, one application service might be deployed in multiple edge application servers (EASs) in different sites, which can be deployed centrally or locally. While these multiple EAS instances (that host same content(s) or service(s)) use different IP addresses, an application or a UE starts to connect to a suitable EAS with the discovered IP address, in order that the traffic can be locally routed between the UE and the EAS, and that service latency, traffic routing path, and user service experience can be optimized.

Currently, an AF provides traffic routing information to a UDR via an AF influenced traffic routing procedure, including a list of data network access identifier(s) (DNAI(s)) per an application or per traffic. The traffic routing information can be included in AF request(s), to influence traffic routing for session(s) which are identified or not identified by an UE address. Whether or not the session(s) is identified by an UE address, the traffic routing information will be updated to a SMF as a part of a pccRule, which is identified by flowInfos or appld as described in 3GPP TS29.512. If the AF requests to influence traffic routing for session(s) that is not identified by an UE address, affecting the future PDU sessions, the traffic routing information can be sent and stored in the UDR before a PDU session establishment procedure, and the traffic routing information can be retrieved by a PCF during the PDU session establishment procedure (e.g., per SUPI) and sent to the SMF (e.g., per traffic or an application, if there is traffic for the application).

In particular, several solutions are under discussions of 3GPP SA2 group for a key issue of a discovery of EAS for an enhancement of a support for edge computing in 5GC. In an agreed solution of EAS (re-)discovery over a session breakout connectivity model, a SMF interacts with an EASDF and provides an ENDS client subnet (ECS) option or a local DNS server address, related to candidate DNAI(s) for that FQDN for the UE's location, as a part of rules for handling DNS queries from the UE to the EASDF, the EASDF sends a DNS message to a local DNS server or sends a DNS message to a centralized DNS server with an ECS option as specified in RFC7871. Furthermore, the SMF may update the rules for handling DNS queries from the UE, which may be triggered by the UE's mobility (e.g., when the UE moves to a new location), by a reporting by the EASDF of a DNS query with a certain FQDN, or by an insertion or a removal of a local PSA (e.g., to update rules for handling DNS queries from the UE or by new PCC rule information).

Considering a scale of visiting UE(s) for an application and deployed applications, following problem(s) need to be solved: a SMF may be overloaded for interaction(s) to support a server discovery procedure. Since rules for handling DNS queries from a UE are related to a FQDN for the UE's location, the interaction(s) is performed per a PDU session and even per an application in the PDU session, and thus, the SMF may be overloaded especially in the rush hour for accessing some hot application. However, the same related rules for handling DNS queries from the UE can apply to all UEs which are accessing the application with the same condition. Therefore, interaction(s) for exchanging information for the server discovery procedure should be improved, to alleviate a system's expense and load.

Various embodiments of the present disclosure provide solutions for improving a provisioning method of rules for handling DNS queries from a UE, so that interaction(s) for transmitting or updating rules for handling DNS queries from the UE is reduced which leads to less system load and high efficiency. For instance, in some embodiments of the present disclosure, rules for handling DNS queries can be associated with a service area of a DNS server, which may be one or more DNAIs or may be one or more identifiers different from a DNAI (e.g., a server area identifier identifying two or more DNAIs sharing the same DNS server for a DNS resolution)), and the rules for handling DNS queries can be also be implemented to be associated with a service area with its associated a DNS server, which may be one or more DNAIs or may be one or more identifiers different from a DNAI (e.g., a server area identifier identifying two or more DNAIs sharing the same DNS server for a DNS resolution)). In some embodiments of the present disclosure, a way for an EASDF requesting to handle DNS information based on a DNS query with a certain FQDN is clarified. Some embodiments of the present disclosure improve interaction(s) for exchanging information for a server discovery procedure, in which DNS configuration information per a node (e.g., a network function) can be provisioned and serving DNS information for an individual PDU session for a UE can be informed to an EASDF in time for choosing information relating to the server discovery procedure. More details will be illustrated in the following text in combination with the appended drawings.

In the present disclosure, the term “DNS configuration information” can be named as DNS related information or DNS routing information. According to some embodiments of the present disclosure, the DNS configuration information includes a list of DNS server(s) (e.g., a local DNS server and/or a central DNS server), a list of service area(s), and/or supported FQDN(s) for a server discovery procedure for application(s) deployed in EDNs or local DNs, e.g., this can be done via a local configuration on the AF. The DNS configuration information can also be implemented to include a list of service area(s) (which may be one or more DNAIs or may be one or more identifiers different from a DNAI (e.g., a server area identifier identifying two or more DNAIs sharing the same DNS server for a DNS resolution)), one or more DNS server(s) (e.g., a local DNS server and/or a central DNS server), and/or supported FQDN(s) for a server discovery procedure for application(s) deployed in EDNs or local DNs.

In the present disclosure, the term “rules for handling DNS message(s)” may also be named as rules for handling DNS information, DNS message handling rule(s), rules for handling DNS query (or queries) or the like. According to some embodiments of the present disclosure, the rules for handling DNS message(s) may include a DNS message reporting rule and/or a DNS message forwarding rule.

In the present disclosure, the terms “one or more DNS server address(es)”. “one or more DNS server(s)”, and “a list of one or more DNS server(s)” are used to identify one or more DNS servers.

In the present disclosure, the terms “per node”, “a node level procedure” and “DNS information of a node-level” are used. The node is the related NF, e.g. the SMF or the EASDF. The information exchanged via “a node level procedure” or “per node” is the related information of a node-level, which can be applied to any PDU session associated with the node.

It should be understood that other terms can be used to refer to the same information as the above terms, without departing from the spirit and scope of the disclosure.

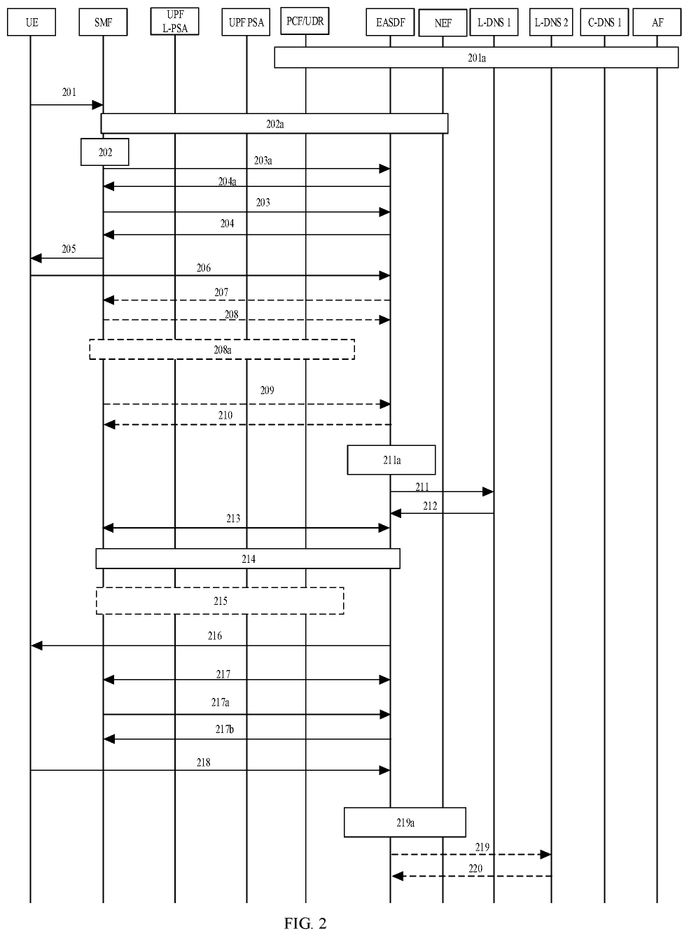

FIG. 1B illustrates an exemplary flow chart of a method for performing a server discovery handling procedure, in accordance with some embodiments of the present application. The exemplary method 100B illustrated in FIG. 1B may be implemented by a network function of a network (e.g., an EASDF as illustrated and shown in any of FIGS. 2 and 5-7). Although described with respect to a network function, it should be understood that other devices may be configured to perform a method similar to that of FIG. 1B.

In operation 101B of FIG. 1B, a network function (e.g., an EASDF) of a network receives serving DNS information from a further network function (e.g., a SMF as illustrated and shown in any of FIGS. 2, 4, 5, and 7) of the network. In some embodiments, the network function is an EASDF, and the further network function is a SMF. In operation 102B of FIG. 1B, the network function selects a DNS server or an ECS option for a FQDN originating from a UE (e.g., a UE as illustrated and shown in any of FIGS. 2, 5, and 7). For instance, the DNS server or the ECS option may be selected based on: (a) the serving DNS information received in operation 101B; and (b) “DNS configuration information of the network” and/or “one or more rules for handling DNS information”.

In some embodiments, the network function further buffers a received DNS query message, and waits for updated information relating to the serving DNS information. In some embodiments, the DNS server is associated with the FQDN in a received DNS query message, and the network function further forwards the received DNS query message to the selected DNS server. In some other embodiments, the ECS option may be associated with a PSA for the FQDN in a received DNS query message. In some embodiments, the ECS option is associated with the FQDN in a received DNS query message, and the network function further forwards the received DNS query message with the selected ECS option.

In some embodiments, the serving DNS information received by the network function in operation 101B is included in at least one of:
(1) A notification indicating a change of the serving DNS information from the further network function. To trigger the notification indicating the change of the serving DNS information from the further network function, a subscription procedure for the notification indicating the change of the serving DNS information from the further network function may be performed. For example, the change of the serving DNS information is triggered by: a mobility of the UE; an insertion of a local PSA; and/or a removal of the local PSA.
(2) A message associated with a DNS context create procedure.
(3) A message associated with a DNS context update procedure.

In some embodiments, the network function further receives updated serving DNS information from the further network function. In some embodiments, the serving DNS information and/or the updated serving DNS information are used for indicating a condition for selecting the DNS server or a condition for handling DNS information. For example, the serving DNS information and/or the updated serving DNS information include: a list of DNAI(s); an identifier for identifying a service area of a serving DNS server; and/or an ECS option for handling DNS information. Each DNAI within the list of DNAI(s) may be associated with an up path for a PDU session.

In some embodiments, the rules for handling DNS information in operation 102B includes: a DNS information reporting rule; and/or a DNS information forwarding rule. For instance, the DNS information forwarding rule may include: ECS option(s) for handling the DNS information; and/or information relating to DNS server(s). The information relating to DNS server(s) may include: a list of DNS server(s); a list of service area(s); and/or a list of supported FQDN(s).

In some embodiments, the network function retrieves the DNS configuration information of the network via a pull mode or a push mode. In some embodiments, the network function receives the DNS configuration information on a per a network function basis. For instance, the DNS configuration information is received via a DNS configuration management procedure. In some embodiments, the DNS configuration information is received from a SMF and/or a NEF of the network. In an embodiment, the DNS configuration information received from the NEF is obtained from an AF of the network. In a further embodiment, the DNS configuration information received from the NEF is stored in a UDR of the network.

In some embodiments, the DNS configuration information of the network includes at least one of:
(1) A list of DNS server(s). The list of DNS server(s) may include a local DNS server and/or a central DNS server.
(2) A list of service area(s).
(3) A list of supported FQDN(s).

Details described in the embodiments as illustrated and shown in FIGS. 1A, 1C, and 2-8 (especially, contents regarding serving DNS information, DNS configuration information, and rules for handling DNS information) are applicable for the embodiments as illustrated and shown in FIG. 1B. Moreover, details described in the embodiments of FIG. 1B are applicable for all the embodiments of FIGS. 1A, 1C, and 2-8.

FIG. 1C illustrates an exemplary flow chart of a method for transmitting serving DNS information, in accordance with some embodiments of the present application. The exemplary method 100C illustrated in FIG. 1C may be implemented by a network function of a network (e.g., a SMF as illustrated and shown in any of FIGS. 2, 4, 5, and 7). Although described with respect to a network function, it should be understood that other devices may be configured to perform a method similar to that of FIG. 1C.

In operation 101C of FIG. 1C, a network function (e.g., a SMF) of a network receiving DNS configuration information of the network. In operation 102C of FIG. 1C, the network function transmits: (a) serving DNS information; and (b) “the DNS configuration information of the network” and/or “one or more rules for handling DNS information”, so as to select a DNS server or an ECS option for a FQDN originating from a UE. In some embodiments, the network function is a SMF, and the further network function is an EASDF.

In some embodiments, in operation 101C of FIG. 1C, the network function receives the DNS configuration information via a DNS configuration management procedure from a network exposure function (NEF) of the network. In some embodiments, in operation 102C of FIG. 1C, the network function transmits the DNS configuration information via a DNS configuration management procedure.

In some embodiments, the serving DNS information transmitted by the network function to the further network function in operation 102C is included in at least one of:
(1) A notification indicating a change of the serving DNS information to the further network function. To trigger the notification indicating the change of the serving DNS information to the further network function, a subscription procedure for the notification indicating the change of the serving DNS information from the further network function may be performed. For example, the change of the serving DNS information is triggered by: a mobility of the UE; an insertion of a local PSA; and/or a removal of the local PSA.
(2) A message associated with a DNS context create procedure.
(3) A message associated with a DNS context update procedure.

In some embodiments, the network function further transmits updated serving DNS information to the further network function. In some embodiments, the serving DNS information and/or the updated serving DNS information are used for indicating a condition for selecting the DNS server or a condition for handling DNS information. For example, the serving DNS information and/or the updated serving DNS information include: a list of DNAI(s); an identifier for identifying a service area of a serving DNS server; and/or an ECS option for handling DNS information. Each DNAI within the list of DNAI(s) may be associated with an up path for a PDU session.

In some embodiments, the DNS configuration information of the network transmitted by the network function in operation 102C of FIG. 1C includes at least one of:
(1) A list of DNS server(s). The list of DNS server(s) may include a local DNS server and/or a central DNS server.
(2) A list of service area(s).
(3) A list of supported FQDN(s).

In some embodiments, the network function retrieves the DNS configuration information of the network via a pull mode or a push mode. In some embodiments, the network function receives the DNS configuration information from a NEF of the network. In an embodiment, the DNS configuration information received from the NEF is obtained from an AF of the network. In a further embodiment, the DNS configuration information received from the NEF is stored in a UDR of the network.

In some embodiments, the rules for handling DNS information transmitted by the network function in the embodiments of FIG. 1C includes: a DNS information reporting rule; and/or a DNS information forwarding rule. For instance, the DNS information forwarding rule may include: ECS option(s) for handling the DNS information; and/or information relating to DNS server(s). The information relating to DNS server(s) may include: a list of DNS server(s); a list of service area(s); and/or a list of supported FQDN(s).

Details described in the embodiments as illustrated and shown in FIGS. 1A, 1B, and 2-8 (especially, contents regarding serving DNS information, DNS configuration information, and rules for handling DNS information) are applicable for the embodiments as illustrated and shown in FIG. 1B. Moreover, details described in the embodiments of FIG. 1B are applicable for all the embodiments of FIGS. 1A, 1B, and 2-8.

FIG. 2 illustrates a flow chart of an exemplary DNS configuration per node via SMF, in accordance with some embodiments of the present disclosure.

The embodiments of FIG. 2 have the following assumptions. Specifically, the embodiments shown in FIG. 2 assume that a service provider may deploy services or applications into an edge data network (EDN, also referred to as a local DN). A local DNS server (e.g., L-DNS 1 or L-DNS 2 as shown in FIG. 2) can be deployed and used for resolving a FQDN received from a UE into an IP address of a suitable edge application server within the local DN. The local DNS server can serve one or more EDNs. A central DNS server (e.g., C-DNS 1 as shown in FIG. 2) supporting an ECS option can be deployed and used for resolving a FQDN received from the UE into an IP address of a suitable edge application server. An AF can get DNS server configuration information (or DNS routing information, which includes a service area for each DNS server, and the supported FQDNs) for a server discovery procedure for applications deployed in the EDNs or local DNs, e.g., this can be done via a local configuration on the AF. The central DNS server can be set as a default DNS server serving the FQDN and the UE which cannot be served by any local DNS server. The AF sends DNS server configuration information that is not identified by an UE's address to the core network. The embodiments shown in FIG. 2 also assume that information on the server discovery procedure is sent out to impact all the related DNS resolutions accessing the related application from any UE for existing PDU session(s) or future PDU session(s). The information can also be updated due to a change of an application deployment or a DNS server deployment within the EDNs or local DNs.

As shown in step 201 of FIG. 2, a UE sends a PDU Session Establishment Request to a SMF. In step 201a of FIG. 2, DNS configuration information is provided from an AF to 5GC, and the DNS configuration information received can be stored in a NEF or an UDR. The AF can send the DNS configuration information which is not identified by an UE address to the 5GC impacting existing PDU session(s) or future PDU session(s).

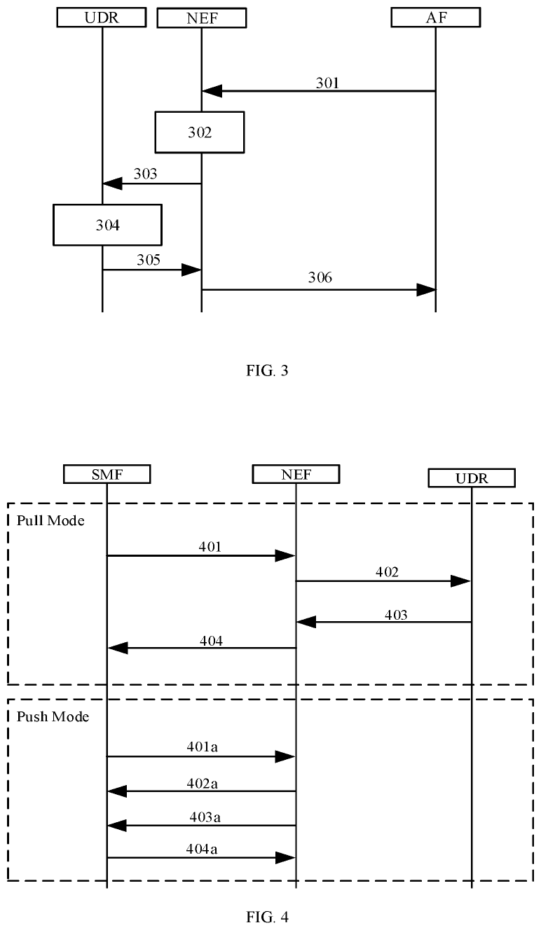

According to some embodiments of the present disclosure, the DNS configuration information in following Table 1 may be sent to 5GC. The DNAIs can share the same L-DNS server to use the same L-DNS server. A specific example for providing DNS configuration information is described in FIG. 3 as follows.

TABLE 1

DNN1+SNSSAI1
L-DNS1, DNAI1, FQDNlist (FQDN1, FQDN2, ..., FQDNr)
L-DNS2, DNAI2, FQDNlist (FQDN1, FQDN2, ..., FQDNs)
...
L-DNSn, DNAIn, FQDNlist (FQDN1, FQDN2, ..., FQDNt)

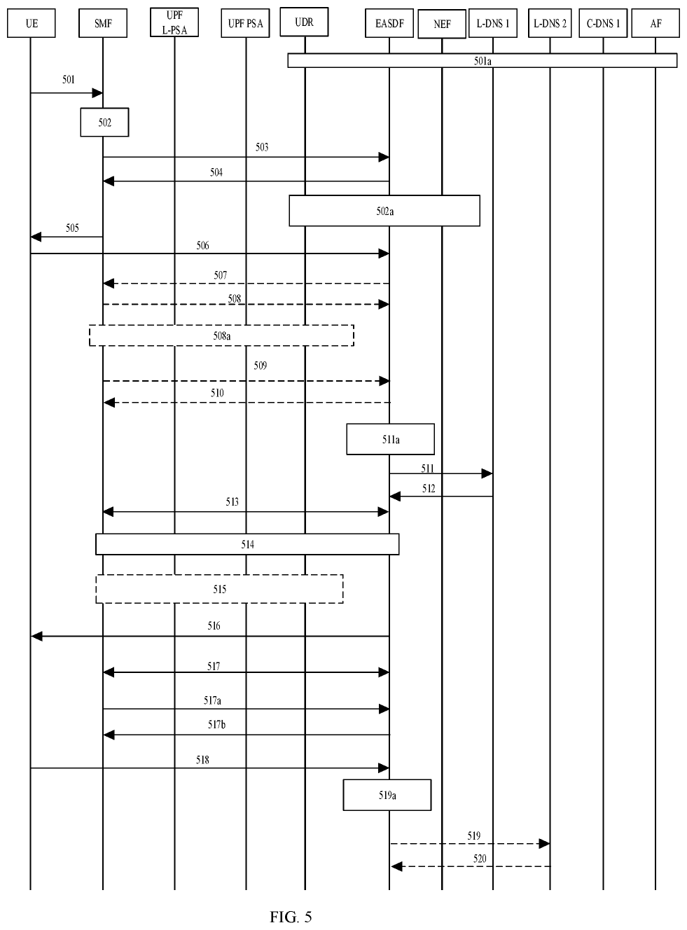

In step 202a of FIG. 2, the SMF can receive the DNS configuration information via a pull mode or a push mode. Similar procedures for PFD management can be provided to support this. A specific example for receiving the DNS configuration information via a pull mode or a push mode is described in FIG. 4 as follows.

In step 202 of FIG. 2, the SMF selects an EASDF. This selection operation may use a NRF discovery procedure or may be based on SMF local configuration information. The EASDF may have registered onto the NRF.

In step 203a of FIG. 2, the SMF sends a DNS configuration request to the EASDF, to provision or remove the DNS configuration information corresponding to DNN(s)/S-NSSAI(s) and/or DNAI(s). This interaction with the EASDF is a node level procedure, i.e., independent of any PDU Session, from which the received DNS configuration information received can be applied to any PDU session associated with the node (e.g. network function of EASDF). The SMF is triggered to provision or remove the DNS configuration information of DNN/S-NSSAI and/or DNAI(s) and/or application(s) in following three cases:
(1) When a caching timer expires and there is no PDU session that refers to the corresponding a DNN/S-NSSAI and/or DNAI(s) and/or application(s), the SMF informs the EASDF to remove the DNS configuration information of DNN/S-NSSAI and/or DNAI(s) and/or application(s).
(2) When a DNS configuration information of DNN/S-NSSAI and/or DNAI(s) and/or application(s) is provided that is not already provided to the EASDF, the SMF shall provide the DNS configuration information of DNN/S-NSSAI and/or DNAI(s) and/or application(s) to the EASDF. If there is no DNS configuration information of DNN/S-NSSAI and/or DNAI(s) and/or application(s) cached, the SMF retrieves it from the NEF, as described above.
(3) When any update of the DNS configuration information of DNN/S-NSSAI and/or DNAI(s) and/or application(s) is received from the NEF, and there are still valid DNS context corresponding to a valid PDU session in the EASDF for the DNN/S-NSSAI and/or DNAI(s).

In step 204a of FIG. 2, the EASDF updates the DNS configuration information of DNN/S-NSSAI and/or DNAI(s) and/or application(s) according to a DNS configuration request message; and the EASDF acknowledges by responding a DNS configuration response message to the SMF. In particular, the DNS configuration request message can also be implemented by invoking a Neasdf_DNSConfiguration_Create Request message to the selected EASDF to create the DNS context information of node-level on the EASDF, and DNS configuration response message also be implemented by invoking a Neasdf_DNSConfiguration_Create Response. The DNS context information on the EASDF may be updated or deleted. Sending the DNS context information from the SMF to the EASDF can be seen as one exemplary DNS configuration management procedure.

In step 203 of FIG. 2, the SMF creates a DNS context on the EASDF by invoking a Neasdf_DNSContext_Create Request message to the selected EASDF. The Neasdf_DNSContext_Create Request message includes a UE IP address, a callback URI, rule(s) for handling DNS message(s) from the UE, and/or serving DNS information). The rules for handling DNS message(s) from the UE may include a DNS message reporting rule.

According to some embodiments, the serving DNS information may be included, e.g., if the DNS configuration information has been already provided to the EASDF. The serving DNS information indicates a condition for handling DNS message(s) forwarding for a PDU session. The condition can be: (1) the current service area which is associated with one of DNS server(s); and (2) a DNAI of a PSA UPF providing an up path for supported FQDN(s) for the PDU session. To save the system complexity, if the DNS server serves two or more DNAIs, the serving DNS information can be associated with a list of DNAI(s) which share the same DNS server information with the current accessing DNAI. Alternatively, to save the system complexity, a new identifier for DNS server accessing may correspond to a list of DNAI(s) which share the same DNS server information with the current accessing DNAI. The ECS(s) option corresponding to the current PSA(s) of the PDU session may also be provided to the EASDF.

According to some embodiments, the DNS message reporting rule included in the rules for handling DNS message(s) may include a reporting condition for the EASDF, to report DNS information (which includes EAS related information) to the SMF when the EASDF receives DNS queries or DNS responses.
(1) For the EASDF to process a DNS query message for ECS option(s) or a local DNS server address handling procedure, the SMF may provide a reporting rule to instruct the EASDF to send EAS FQDN(s) to the SMF, if the EAS FQDN(s) in the DNS query message matches FQDN(s) filters in the DNS message reporting rule; and the EASDF can buffer the DNS query message and wait for the serving DNS information (and/or updated serving DNS information) for forwarding the buffered DNS query message.
(2) For EASDF to process a DNS response message for a specific IP address or FQDN range(s), the SMF may provide a reporting rule to instruct the EASDF to report an EAS IP address or FQDN(s) to the SMF, if the EAS IP address in the DNS responses message matches one of IP address range(s) of the reporting rule, or if the FQDN in the DNS response message matches one of FQDN(s) in the DNS message reporting rule.

According to some embodiments, the EASDF is provisioned with the DNS configuration information of a node-level, before the DNS query message is received by the EASDF (there is already DNS context for a PDU session for the same DNN/S-NSSAI, an application, and/or DNAI(s), and the corresponding DNS configuration information has been received by the EASDF before). According to some other embodiments, the EASDF is provisioned with the DNS configuration information of a node-level, as a consequence of the DNS query reporting (e.g., this is the first DNS context for the PDU session for the DNN/S-NSSAI, an application, and/or DNAI(s), and the corresponding DNS configuration information has not been received by the EASDF. In particular, after receiving the DNS query message, the EASDF may send a DNS message report to the SMF as specified in step 207, and the SMF may provide the DNS configuration information to the EASDF triggered by the DNS message report of the DNS query message.)

In step 204 of FIG. 2, the EASDF sends a response to the SMF, including an IP address of the EASDF and with information allowing later the SMF to update or delete the context. In step 205 of FIG. 2, the SMF includes the IP address of the EASDF as a DNS server in a PDU Session Establishment Accept message. In step 206 of FIG. 2, the UE sends a DNS query message to the EASDF.

In step 207 of FIG. 2, if the DNS query message matches the DNS message reporting condition for the UE, the EASDF sends a DNS message report to the SMF. In step 208 of FIG. 2, the SMF responds to the EASDF for the DNS message report received in step 207. The step 207 and step 208 of FIG. 2 are optional.

In step 209 of FIG. 2, if needed, the SMF updates the DNS context on the EASDF by invoking a Neasdf_DNSContext_Update Request message to the EASDF. The Neasdf_DNSContext_Update Request message may include a PDU session context ID, and/or the serving DNS information which is similar to that in step 203 of FIG. 2. The update may be triggered by a UE's mobility (e.g., when UE moves to a new location) or by a reporting by the EASDF of a DNS query message with a certain FQDN. Alternatively, the update may be triggered by an insertion or a removal of a local PSA, e.g., to update the rules for handling DNS message(s) from the UE. In step 210 of FIG. 2, the EASDF responds with a Neasdf_DNSContext_Update Response message.

In step 211a, step 211, and step 212 of FIG. 2, the EASDF may handle the DNS query message received from the UE as follows:
(1) Option A: the EASDF adds the ECS option into the DNS query message as specified in RFC7871 [6] and sends the DNS query message to C-DNS server. If there are two or more PSAs in the PDU session, each ECS per a PSA is sent to the EASDF, and the EASDF chooses an appropriate ECS for the FQDN received in the DNS query message. The ECS options can be included as a part of the serving DNS information, or separately or as a part of the rules for handling DNS message(s).
(2) Option B: the EASDF selects an appropriate DNS server by considering DNS configuration information, serving DNS information, and the FQDN received in the DNS query message; and the EASDF sends the DNS query message to the selected DNS server.

According to some embodiments, if neither a reporting rule nor a forwarding rule provided by the SMF nor the DNS configuration information matches the requested FQDN in the DNS query message, the EASDF may simply forward the DNS query message to a pre-configured DNS server or resolver.

In step 213 of FIG. 2, the EASDF may subscribe a notification of a change or an update of the serving DNS information from the SMF. The change or update may be triggered by the UE's mobility (e.g. when the UE moves to a new location) or by an insertion or a removal of a local PSA. The SMF makes a decision for the serving DNAI for the PDU session. When the UE moves, the serving DNAI may be kept and the serving DNS information may be kept. Even if the serving DNAI changes, the serving DNS information may be kept too, for example, this case corresponds to the case that the same DNS server serves two or more DNAIs.

In step 214 of FIG. 2, the EASDF may send DNS message reporting information to the SMF to notify EAS information, if the EAS IP address or the FQDN in the DNS response message matches the reporting condition provided by the SMF.

In step 215 of FIG. 2, the SMF may perform UL CL/BP and a local PSA selection procedure, and the SMF may insert UL CL/BP and a local PSA triggered by the notification of the DNS response message in step 214 of FIG. 2. In step 216 of FIG. 2, the EASDF sends the DNS response message to the UE.

In step 217 of FIG. 2, if serving DNS information changes, e.g., triggered by an local PSA insertion in step 215 of FIG. 2, the SMF notifies the serving DNS information change to the EASDF, which can indicate the latest serving DNS information to the EASDF. The latest serving DNS information can be the DNAIs for the existing PSAs in the PDU session, which corresponds to different DNS message forwarding rules with its DNS server information.

In steps 217a and 217b of FIG. 2, alternatively, not using the notification mechanism, the SMF may invoke a Neasdf_DNSContext_Update service, to update the serving DNS information to the EASDF.

In step 218 of FIG. 2, the UE sends a new DNS query message to the EASDF.

In steps 219a and 220 of FIG. 2, the EASDF handles the DNS query message received from the UE according to the DNS configuration information, current serving DNS information, and the FQDN received in the DNS Query, which are similar to steps 211a, 211, and 212 of FIG. 2.

FIG. 3 illustrates a flow chart of an exemplary DNS configuration management procedure for providing DNS configuration information, in accordance with some embodiments of the present disclosure. In the embodiments shown in FIG. 3, DNS configuration information may be provided via following procedure.

In step 301 of FIG. 3, an AF sends a request, to invoke a Nnef_DNSConfiguraiton_Create service, a Nnef_DNSConfiguraiton_Update service, or a Nnef_DNSConfiguraiton_Delete service. Allowed delay is an optional parameter. If the allowed delay is included, the allowed delay indicates that DNS configuration information with a list of DNS server(s) in this request in step 301 should be provisioned within a time interval indicated by the allowed delay to SMF(s) that have subscribed to a DNS configuration service using a Nnef_DNSConfiguration_Subscribe service.

In step 302 of FIG. 3, a NEF checks whether an AF or an application is authorized to perform this request based on the operator policies. In step 303 of FIG. 3, the NEF may invoke a Nudr_DM_Create Request message, a Nudr_DM_Update Request message, or a Nudr_DM_Delete Request message to an UDR, to store, update, or delete DNS configuration information. The DNS configuration information may include a list of DNS server(s) (e.g., L-DNS 1, L-DNS 2 and/or a C-DNS 1 as shown in FIG. 2), a list of service area(s), and/or supported FQDN(s).

In step 304 of FIG. 3, the UDR creates, updates, or deletes the DNS configuration information of the DNS server or the list of DNS server(s). In step 305 of FIG. 3, the UDR sends a Nudr_DM_Create Response message, a Nudr_DM_Update Response message, or a Nudr_DM_Delete Response message to the NEF. In step 306 of FIG. 3, the NEF sends the Nnef_DNSConfiguration_Create Response message, the Nnef_DNSConfiguration_Update Response message, or the Nnef_DNSConfiguration_Delete Response message to the AF.

FIG. 4 illustrates a flow chart of two exemplary DNS configuration management procedures for receiving DNS configuration information, in accordance with some embodiments of the present disclosure.

In the embodiments shown in FIG. 4, a SMF may receive DNS configuration information via a pull mode or a push mode. Similar procedures for PFD management can be provided to support this procedure. The procedures in the embodiments shown in FIG. 4 enable the SMF to receive DNS configuration information of DNN/S-NSSAI and/or DNAI(s) and/or application(s), when a PDU session for the DNN/S-NSSAI and/or DNAI(s) is established and DNS configuration information provided by a NEF are not available at the SMF. In addition, the procedures in the embodiments shown in FIG. 4 also enable the SMF to retrieve DNS configuration information from the NEF when a caching timer for the DNS configuration elapses and there is PDU session(s) for this DNN/S-NSSAI and/or DNAI(s) and/or application(s). Either a complete list of DNS configuration information of all DNS server(s), a complete list of DNS configuration information of one or more DNN/S-NSSAI and/or DNAI(s) and/or application(s), or a subset of DNS configuration information of individual DNN/S-NSSAI and/or DNAI(s) and/or application(s) may be managed.

In particular, for “Pull Mode” in FIG. 4, in step 401, a SMF invokes a Nnef_DNSConfiguration_Fetch message to a NEF, e.g., for fetching DNN/S-NSSAI and/or DNAI(s) and/or application(s). The SMF may fetch all DNS configuration information of the DNN/S-NSSAI or for DNAI(s). In step 402, the NEF checks whether the DNS configuration information of the DNN/S-NSSAI and/or DNAI(s) and/or application(s) is available in the NEF. If available, the NEF skips to step 404 of FIG. 4. If not, the NEF invokes a Nudr_DM_Query message (for DNN/S-NSSAI and/or DNAI(s) and/or application(s)) to retrieve the DNS configuration information from an UDR.

In step 403 of FIG. 4, the UDR provides a Nudr_DM_Query response message with the DNS configuration information to the NEF. The DNS configuration information may include a list of DNS server(s) (e.g., L-DNS 1, L-DNS 2 and/or a C-DNS 1 as shown in FIG. 2), a list of service area(s), and supported FQDN(s). In step 404 of FIG. 4, the NEF replies to the SMF with Nnef_DNSConfiguration_Fetch Response message with the DNS configuration information, which may include the list of DNS server(s) (e.g., L-DNS 1, L-DNS 2 and/or a C-DNS 1 as shown in FIG. 2), a list of service area(s), and/or supported FQDN(s).

For “Push Mode” in FIG. 4, in step 401a, a SMF sends a Nnef_DNSConfiguration_Subscribe Request message to a NEF. In step 402a, the NEF sends a Nnef_DNSConfiguration_Subscribe Response message to the SMF. In step 403a, the NEF invokes a Nnef_DNSConfiguration_Notify Request message (e.g., including DNN/S-NSSAI and/or DNAI(s) and/or application(s), and/or DNS configuration information) to the SMF to which the DNS configuration information shall be provided. The NEF may decide to delay a distribution of the DNS configuration information to the SMF for some time, to optimize a signalling load. In step 404a, the SMF sends a Nnef_DNSConfiguration_Notify Response message to the NEF. If the NEF receives an allowed delay for the DNS configuration information, the NEF shall distribute this DNS configuration information within the indicated time interval.

In the above embodiment described in FIG. 4, the DNS configuration information is received from the NEF directly. Alternatively, the DNS configuration information can be received from the UDR directly, which requires the similar interaction between the SMF and the UDR by invoking similar service(s) with the same logic as described in FIG. 4 provided by the UDR or by invoking improved Nudr_DM_Query service to include the DNS configuration information.

FIG. 5 illustrates a further flow chart of an exemplary DNS configuration per node to EASDF, in accordance with some embodiments of the present disclosure. The embodiments of FIG. 5 have the same assumptions as those in the embodiments of FIG. 2 described above. For example, in the embodiments shown in FIG. 5, a service provider may deploy services or applications into edge data networks (EDNs, also referred to as local DNS).

Specifically, as shown in step 501 of FIG. 5, a UE sends a PDU Session Establishment Request message to a SMF. In step 501a of FIG. 5, DNS configuration information is provided from the AF to the 5GC. The received DNS configuration information can be stored in a NEF or an UDR, which is the same as step 201a in the embodiments of FIG. 2.

In step 502 of FIG. 5, the SMF selects an EASDF. This selection operation may use a NRF discovery procedure or may be based on SMF local configuration information. The EASDF may have registered onto the NRF.

In step 503 of FIG. 5, the SMF creates a DNS context on the EASDF by invoking a Neasdf_DNSContext_Create Request message to the selected EASDF. For example, the Neasdf_DNSContext_Create Request message includes a UE IP address, a callback URI, rule(s) for handling DNS messages from the UE, and/or serving DNS information. The rules for handling DNS message(s) from the UE may include one or more DNS message forwarding rules and/or one or more DNS message reporting rules. The serving DNS information may be included, e.g., if the DNS configuration information has been already provided to the EASDF. The serving DNS information indicates a condition for handling DNS message(s) forwarding for a PDU session. The condition can be a current service area which is associated with one of the DNS server. The condition can be a DNAI of a PSA UPF providing an up path for supported FQDN(s) for the PDU session. To save the system complexity, if the DNS server serves two or more DNAIs, the serving DNS information can be associated with a list of DNAIs. Alternatively, to save the system complexity, a new identifier for DNS server accessing may correspond to a list of DNAI(s) which share the same DNS server information with the current accessing DNAI. According to some embodiments, ECS option(s) corresponding to the current PSA(s) of the PDU session may also be provided to the EASDF, and the ECS options can be included as a part of the serving DNS information, or separately or as a part of the rules for handling DNS message(s).

According to some embodiments, the DNS message forwarding rule includes DNS server information which include one or more DNS server address(es), a corresponding service area, supported FQDN(s), and/or the ECS option(s) to be added. Whether using Option A (i.e., forwarding the DNS message with added ECS option to the C-DNS) or using Option B (i.e., forwarding the DNS message to the appropriate L-DNS) can be decided based on the configuration or local policy. If the SMF decides an option for forwarding the DNS message, the SMF can provide only the information for the selected option. For example, if option B is used, the SMF can only send the DNS server information to the EASDF, and needs not to send the ECS option(s). The SMF can also send both the DNS server information and the ECS option(s) to the EASDF, and let the EASDF to decide an option for forwarding the DNS message based on a local policy, a configuration, or an implementation.

According to some embodiments, the DNS message reporting rule includes a reporting condition for the EASDF to report the DNS information including EAS related information to SMF, when the EASDF receives DNS queries or DNS responses.
(1) For the EASDF to process a DNS query message with ECS option(s) or a local DNS server address handling, the SMF may provide a reporting rule to instruct the EASDF to send the EAS FQDN(s) to the SMF, if the EAS FQDN in the DNS Query message matches FQDN(s) filters in the DNS message reporting rule, and the EASDF can buffer the DNS query message and wait for the serving DNS information (and/or the updated serving DNS information) and/or the DNS message forwarding rule(s) for forwarding the buffered DNS query message.
(2) For the EASDF to process a DNS response message for a specific IP address or FQDN ranges, the SMF provides a reporting rule to instruct the EASDF to report EAS IP address/FQDN to the SMF, if the EAS IP address in the DNS response message matches one of the IP address range(s) of the reporting rule, or if the FQDN in the DNS response message matches one of the FQDNs in the DNS message reporting rule.

In step 504 of FIG. 5, the EASDF sends a response to the SMF. The response may include an IP address of the EASDF and information allowing later the SMF to update or delete the context.

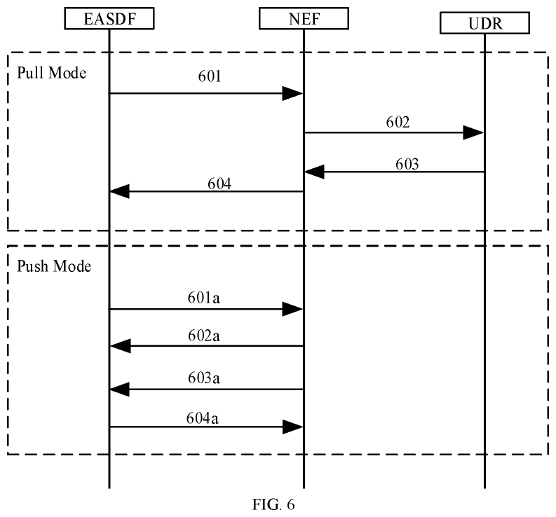

In step 502a of FIG. 5, the EASDF can receive the DNS configuration information of the DNN/S-NSSAI, and/or application(s), and/or DNAI(s), when there is valid DNS context corresponding to a valid PDU session in EASDF for the DNN/S-NSSAI and/or DNAI(s) via a pull mode or a push mode. Similar procedures for PFD management can be provided to support this. A specific example for receiving DNS configuration information via a pull mode or a push mode is described in FIG. 6 as follows.

In step 505 of FIG. 5, the SMF includes the IP address of the EASDF as a DNS server in a PDU Session Establishment Accept message. In step 506 of FIG. 5, the UE sends a DNS query message to the EASDF.

In step 507 of FIG. 5, if the DNS query message matches the DNS message reporting condition for the UE, the EASDF sends the DNS message report to the SMF. In step 508 of FIG. 5, the SMF responds to the EASDF.

In step 509 of FIG. 5, if needed, the SMF updates the DNS context on the EASDF by invoking a Neasdf_DNSContext_Update Request message (e.g., including a PDU session context ID, and/or serving DNS information) to the EASDF. The update may be triggered by the UE's mobility (e.g., when UE moves to a new location) or by a reporting by the EASDF of a DNS query message with a certain FQDN. Alternatively, the update may be triggered by an insertion or a removal of a local PSA, e.g., to update rule(s) for handling DNS message(s) from the UE. The serving DNS information is similar to that in step 503 of FIG. 5. In step 510 of FIG. 5, the EASDF responds with a Neasdf_DNSContext_Update Response message.

In step 511a, step 511, and step 512 of FIG. 5, the EASDF handles the DNS query message received from the UE as follows:
(1) Option A: the EASDF adds the ECS option into the DNS query message as specified in RFC 7871[6] and sends the DNS query message to C-DNS server. If there are two or more PSAs in the PDU session, each ECS per a PSA is sent to the EASDF; and the EASDF chooses an appropriate ECS for a FQDN received in the DNS query message. The ECS options can be included as a part of serving DNS information, or separately or as a part of the rules for handling DNS message(s).
(2) Option B: the EASDF selects an appropriate DNS server by considering: DNS configuration information and/or the DNS message forwarding rule(s), serving DNS information, and the FQDN received in the DNS query message; and the EASDF sends the DNS query message to the selected DNS server.

According to some embodiments, if neither a reporting nor a forwarding rule provided by the SMF nor the DNS configuration information matches the requested FQDN in the DNS query message, the EASDF may simply forward the DNS query message to a pre-configured DNS server or resolver.

In step 513 of FIG. 5, the EASDF may subscribe a notification of a change or update of serving DNS information from the SMF. The change or update may be triggered by the UE's mobility (e.g. when the UE moves to a new location) or by an insertion or a removal of a local PSA. The SMF makes a decision for the serving DNAI for the PDU session. When the UE moves, the serving DNAI may be kept and the serving DNS information may be kept. Even if the serving DNAI changes, the serving DNS information may be kept too, for example, this case corresponds to the case that the same DNS server serves two or more DNAIs.

In step 514 of FIG. 5, the EASDF may send DNS message reporting information to the SMF to notify EAS information, if the EAS IP address or the FQDN in the DNS response message matches the reporting condition provided by the SMF. In step 515 of FIG. 5, the SMF may perform UL CL/BP and Local PSA selection and insert UL CL/BP and a local PSA triggered by the notification of DNS response message in step 514. In step 516 of FIG. 5, the EASDF sends the DNS response message to the UE.

In step 517 of FIG. 5, if serving DNS information changes, e.g., triggered by a local PSA insertion in step 515, the SMF notifies the serving DNS information change to the EASDF, which can indicate the latest serving DNS information to the EASDF. The latest serving DNS information can be DNAIs for existing PSA(s) in the PDU session, and the DNAIs correspond to different DNS message forwarding rule with its DNS server information. The ECS(s) option corresponding to the current PSA(s) of the PDU session may also be notified to the EASDF.

In steps 517a and 517b of FIG. 5, alternatively, not using the notification mechanism, the SMF may invoke a Neasdf_DNSContext_Update service, to update the serving DNS information to the EASDF.

In step 518 of FIG. 5, the UE sends a new DNS query message to the EASDF. In steps 519a and 520 of FIG. 5, the EASDF handles the DNS query message received from the UE according to the DNS configuration information, current serving DNS information, and the FQDN received in the DNS query message, which are similar to steps 511a-512.

FIG. 6 illustrates a further flow chart of two exemplary DNS configuration management procedures for receiving DNS configuration information, in accordance with some embodiments of the present disclosure.

In the embodiments shown in FIG. 6, an EASDF may receive DNS configuration information via a pull mode or a push mode. The procedures in the embodiments shown in FIG. 6 enable the EASDF to receive DNS configuration information of DNN/S-NSSAI and/or DNAI(s) and/or application(s), when a PDU session for the DNN/S-NSSAI and/or DNAI(s) is established and DNS configuration information provided by the NEF are not available at the EASDF. In addition, the procedures in the embodiments shown in FIG. 6 also enable the EASDF to retrieve DNS configuration from the NEF, when a caching timer for the DNS configuration elapses and there is PDU session(s) for this DNN/S-NSSAI and/or DNAI(s). Either a complete list of DNS configuration information of all DNS servers, a complete list of all PFDs of one or more DNN/S-NSSAI and/or DNAI(s) and/or application(s), or a subset of DNS configuration information of individual DNN/S-NSSAI and/or DNAI(s) and/or application(s) may be managed.

In the embodiments shown in FIG. 6, the EASDF is provisioned with the DNS configuration information of a node-level, before a DNS query message is received at the EASDF (there is already DNS context for the PDU session for the same DNN/S-NSSAI, and/or application, and/or DNAI(s), and the corresponding DNS configuration has been received by the EASDF before). In some other embodiments shown in FIG. 6, the EASDF is provisioned with the DNS configuration information of a node-level, as a consequence of the EASDF receiving a DNS query message (e.g., this is the first DNS context for the PDU session for the DNN/S-NSSAI, and/or application, and/or DNAI(s), and the corresponding DNS configuration has not been received by the EASDF. In particular, after receiving the DNS query message, the EASDF may initiate the procedure for DNS configuration information procedure, e.g., Nnef_DNSConfiguration_Fetch procedure as specified in step 601.)

In particular, for “Pull Mode” in FIG. 6, in step 601, the EASDF invokes a Nnef_DNSConfiguration_Fetch Request message to the NEF. For example, the Nnef_DNSConfiguration_Fetch Request message includes DNN/S-NSSAI and/or DNAI(s) and/or application(s). The EASDF may fetch all DNS configuration information of the DNN/S-NSSAI and/or DNAI(s) and/or application(s). In step 602 of FIG. 6, a NEF checks whether the DNS configuration information of the DNN/S-NSSAI and/or DNAI(s) and/or application(s) is available in the NEF. If available, the NEF skips to step 604. If not available, the NEF invokes Nudr_DM_Query message (e.g., including DNN/S-NSSAI and/or DNAI(s)) and/or application(s) to retrieve the DNS configuration information from an UDR.

In step 603 of FIG. 6, the UDR provides a Nudr_DM_Query Response message with DNS configuration information of the DNN/S-NSSAI and/or DNAI(s) and/or application(s) to the NEF. The DNS configuration information may include a list of DNS server(s) (e.g., L-DNS 1, L-DNS 2 and/or a C-DNS 1 as shown in FIG. 5), a list of service area(s), and/or supported FQDN(s). In step 604 of FIG. 6, the NEF replies to the EASDF with a Nnef_DNSConfiguration_Fetch Response message with DNS configuration information. The DNS configuration information may include a list of DNS server(s) (e.g., L-DNS 1, L-DNS 2 and/or a C-DNS 1 as shown in FIG. 5), a list of service area(s), and/or supported FQDN(s).

For “Push Mode” in FIG. 6, in step 601a, the EASDF sends a Nnef_DNSConfiguration_Subscribe Request message to a NEF. In step 602a, the NEF sends a Nnef_DNSConfiguration_Subscribe Response message to the EASDF. In step 603a, the NEF invokes Nnef_DNSConfiguration_Notify Request message (DNN/S-NSSAI and/or DNAI(s) and/or application(s), DNS configuration information) to the EASDF to which the DNS configuration information shall be provided. The NEF may decide to delay the distribution of DNS configuration to the EASDF(s) for some time to optimize the signalling load. In step 604a, the EASDF sends a Nnef_DNSConfiguration_Notify Response message to the NEF. If the NEF received an allowed delay for a DNS configuration, the NEF shall distribute this PFD within the indicated time interval.

In the above embodiment described in FIG. 6, the DNS configuration information is received from the NEF directly. Alternatively, the DNS configuration information can be received from the UDR directly, which requires the similar interaction between the EASDF and the UDR by invoking the similar service(s) with the same logic as described in FIG. 6 provided by the UDR or by invoking improved Nudr_DM_Query service to include the DNS configuration information.

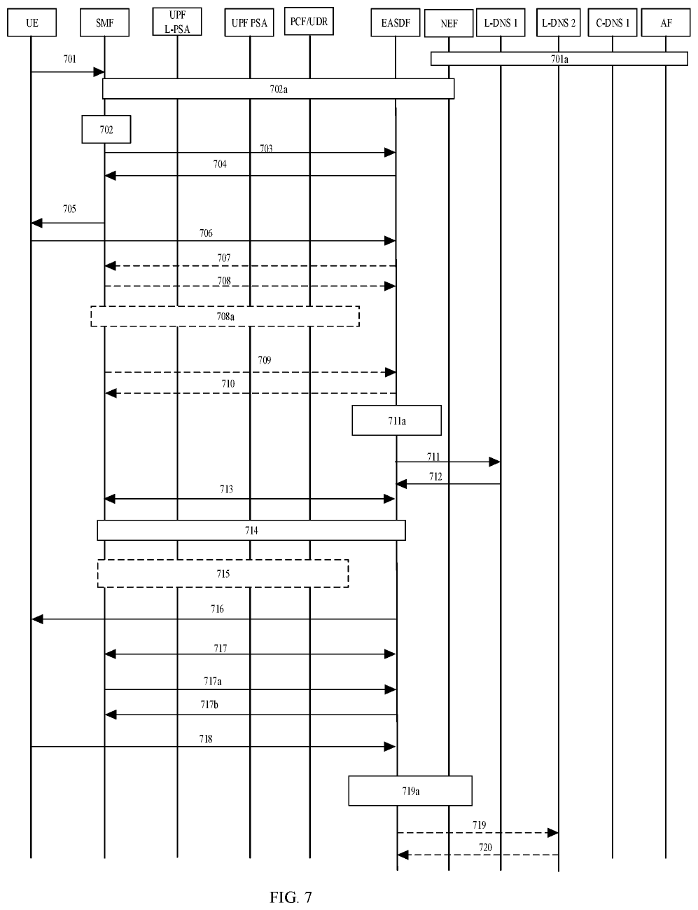

FIG. 7 illustrates another flow chart of an exemplary DNS configuration per PDU session, in accordance with some embodiments of the present disclosure.

The embodiments of FIG. 7 have some same assumptions as those in the embodiments of FIG. 2 described above. For example, in the embodiments shown in FIG. 7, a service provider may deploy services or applications into edge data networks (EDNs, also referred to as local DNs). An AF sends DNS routing information not identified by an UE address to the core network. The method in the embodiments of FIG. 7 can also be applied to the case that to impact existing PDU session(s), e.g., the information is sent to the core network after a PDU session establishment procedure, or the information is updated due to a change of an application deployment within the EDNs or local DNs.

Specifically, as shown in step 701 of FIG. 7, a UE sends a PDU Session Establishment Request message to a SMF.

In step 701a of FIG. 7, DNS configuration information is provided from an AF to 5GC, and the SMF receives the DNS configuration information. The DNS configuration information may include a list of DNS server(s) (e.g., L-DNS 1, L-DNS 2 and/or a C-DNS 1 as shown in FIG. 7), a list of service area(s), and/or supported FQDN(s) for a server discovery procedure for applications deployed in the EDNs or local DNs, e.g., this can be done via a local configuration on the AF. A central DNS server (e.g., C-DNS 1 as shown in FIG. 7) can also be involved and be set as a default DNS server serving the FQDN and the UE which cannot be served by any local DNS server. The AF can send DNS configuration information not identified by a UE address or identified by a UE address to the core network for existing PDU session(s) or future PDU session(s). This can be done by reusing AF influenced traffic routing procedure with improvements to include the DNS configuration information. From DNS configuration information providing point of view, the improved AF influenced traffic routing procedure to include the DNS configuration information can be seen as an exemplary DNS configuration management procedure. Alternatively, the DNS configuration management procedure for providing DNS configuration information can also be implemented by reusing an AF request for external parameter provisioning with improvements to include the DNS configuration information. The DNS configuration information can be stored in NEF and/or the UDR. If the DNS configuration information is further provided per PDU session, the SMF retrieves the DNS configuration information while retrieving a SM policy from the PCF based on the DNS configuration information stored in the NEF or UDR, the DNS configuration information can be included as a part of SessionRule or as a part of PCCRule. Alternatively, the SMF can retrieve the DNS configuration information from the UDR directly via the notification of the provisioned external parameter with the DNS configuration information or via retrieving Session Management Subscription data with the DNS configuration information from the UDM or the UDR.

According to some embodiments, the DNS configuration information in following Table 2 may be sent to the SMF. The DNAIs can share the same L-DNS server to use the same L-DNS server.

TABLE 2

DNN1+SNSSAI1/SUPI
DNAI1, L-DNS1, FQDNlist (FQDN1, FQDN2, ..., FQDNr)
DNAI2, L-DNS2, FQDNlist (FQDN1, FQDN2, ..., FQDNs)
...
DNAIn, L-DNSn, FQDNlist (FQDN1, FQDN2, ..., FQDNt)

In step 702a of FIG. 7, the SMF selects an EASDF. This selection operation may use a NRF discovery or may be based on a SMF local configuration. The EASDF may have registered onto the NRF.

In step 703 of FIG. 7, the SMF creates a DNS context on the EASDF by invoking a Neasdf_DNSContext_Create Request message to the selected EASDF. For example, the Neasdf_DNSContext_Create Request message includes a UE IP address, a callback URI, rule(s) for handling DNS message(s) from the UE, and/or serving DNS information. The rule(s) for handling DNS message(s) from the UE (i.e., DNS message handling rule) may include DNS message forwarding rule and/or DNS message reporting rule.

According to some embodiments, the serving DNS information may be included. The serving DNS information indicates a condition for handling the DNS message forwarding for a PDU session. The condition can be a current service area which is associated with one of the DNS server, and can be a DNAI of a PSA UPF providing an UP path for supported FQDN(s) for the PDU session. To save the system complexity, if the DNS server serves two or more DNAIs, the serving DNS information can be associated with a list of DNAIs or a new identifier for DNS server accessing corresponds to the list of DNAIs which share the same DNS server information with the current accessing DNAI.

According to some embodiments, the ECS option(s) corresponding to the current PSA(s) of the PDU session may also be provided to the EASDF for supporting Option A (i.e., forwarding the DNS message with added ECS option to the C-DNS). The ECS option(s) can be provided as a part of a DNS message forwarding rule which indicates forwarding the DNS message to the C-DNS that adds the included ECS option. Alternatively, the DNS message forwarding rule only indicates the DNS message forwarding rule to the C-DNS that adds an ECS option, but the ECS option(s) for “the supported FQDN(s) and the current PSA(s) of the PDU session” is included in the serving DNS information.

According to some embodiments, the DNS message reporting rule includes a reporting condition for the EASDF, to report the DNS information including EAS related information to SMF, when the EASDF receives DNS queries or DNS responses.

According to some embodiments, for the EASDF to process a DNS query with ECS options or a local DNS server address handling, the SMF may provide one or more reporting rules to instruct the EASDF to send the EAS FQDN(s) to the SMF, if the EAS FQDN in the DNS query message matches FQDN(s) filters in the DNS message reporting rule; and the EASDF can buffer the DNS query message and wait for the DNS message forwarding rule (and/or updated DNS message forwarding rule) and/or the (updated) serving DNS information for forwarding the buffered DNS query message.

According to some other embodiments, for the EASDF to process a DNS response message for a specific IP address or FQDN ranges, the SMF provides a reporting rule to instruct the EASDF to report EAS IP address or FQDN to the SMF, if the EAS IP address in the DNS Responses message matches one of the IP address range(s) of the reporting rule, or if the FQDN in the DNS Response matches one of the FQDNs in the DNS message reporting rule.

According to some embodiments, the EASDF is provisioned with the forwarding rule(s) (i.e., ECS option(s) or local DNS Server(s) for the FQDN(s) and DNAI(s)) before the DNS query message is received at the EASDF. According to some other embodiments, the EASDF is provisioned with the forwarding rule(s), as a consequence of the EASDF receiving a DNS query message as a consequence of the DNS query reporting (e.g., after receiving the DNS query message, the EASDF may send a DNS message report to the SMF as specified in step 207, and the SMF may provide or update the forwarding rule(s).)

According to some embodiments, whether using Option A (i.e., forwarding the DNS message with added ECS option to the C-DNS) or using Option B (i.e., forwarding the DNS message to the appropriate L-DNS) can be decided by the configuration or a local policy. If the SMF decides an option for forwarding the DNS message, the SMF can provide only the information for the selected option. For instance, if option B is used, the SMF can only send the DNS server information to the EASDF, and the SMF does not need to send the ECS option(s). The SMF can also send both the DNS server information and the ECS option(s) to the EASDF, and let the EASDF to decide an option for forwarding the DNS message based on a local policy or a configuration or an implementation. In step 704 of FIG. 7, the EASDF sends a response to the SMF. The response may include an IP address of the EASDF and information allowing later the SMF to update or delete the context.

In step 705 of FIG. 7, the SMF includes the IP address of the EASDF as a DNS server in a PDU Session Establishment Accept message. In step 706 of FIG. 7, the UE sends a DNS query message to the EASDF.

In step 707 of FIG. 7, if the DNS Query message matches the DNS message a reporting condition for the UE, the EASDF sends the DNS message report to the SMF. In step 708 of FIG. 7, the SMF responds to the EASDF.

In step 709 of FIG. 7, if needed, the SMF updates a DNS context on the EASDF by invoking a Neasdf_DNSContext_Update Request message (e.g., including PDU Session Context ID, serving DNS information) to the EASDF. The update may be triggered by the UE's mobility (e.g., when UE moves to a new location) or by a reporting by the EASDF of a DNS query message with a certain FQDN. Alternatively, the update may be triggered by an insertion or a removal of a local PSA, e.g., to update rule(s) for handling DNS message(s) from the UE. The update may be triggered by updating DNS configuration information impacting rules for handling DNS queries from the UE. The rule(s) for handling DNS queries and serving DNS information are similar to that in step 703 of FIG. 7.

In step 710 of FIG. 7, the EASDF responds with a Neasdf_DNSContext_Update Response message. In steps 711a, 711, and 712 of FIG. 7, the EASDF handles the DNS query message received from the UE as follows:
(1) Option A: the EASDF adds an ECS option into the DNS query message as specified in RFC 7871[6] and sends the DNS query message to C-DNS server. If there are two or more PSAs in the PDU session, each ECS per a PSA is sent to the EASDF; and the EASDF chooses an appropriate ECS for the FQDN received in the DNS query message.
(2) Option B: the EASDF selects the appropriate DNS server by considering: rule(s) for handling DNS queries from the UE, serving DNS information, and/or the FQDN(s) received in the DNS query message and sends the DNS query message to the local DNS server.

According to some embodiments, if neither a reporting rule nor a forwarding rule provided by the SMF matches the requested FQDN in the DNS query message, the EASDF may simply forward the DNS query message to a pre-configured DNS server or resolver.

In step 713 of FIG. 7, the EASDF may subscribe a notification of a change or updated of serving DNS information from the SMF. The change or update may be triggered by the UE's mobility (e.g., when UE moves to a new location) or by an insertion or a removal of a local PSA. The SMF makes a decision for the serving DNAI for a PDU session. When the UE moves, the serving DNAI may be kept and the serving DNS information may be kept. Even if the serving DNAI changes, the serving DNS information may be kept too, and this case corresponds to the case that the same DNS server serves two or more DNAIs.

In step 714 of FIG. 7, the EASDF may send DNS message reporting information to the SMF to notify EAS information, if the EAS IP address or the FQDN in the DNS response message matches the reporting condition provided by the SMF. In step 715 of FIG. 7, the SMF may perform a UL CL/BP and local PSA selection operation and may insert UL CL/BP and local PSA triggered by the notification of DNS response message in step 714. In step 716 of FIG. 7, the EASDF sends the DNS response message to the UE.

In step 717 of FIG. 7, if serving DNS information changes (e.g., triggered by a local PSA insertion in step 715), the SMF notifies the serving DNS information change to the EASDF, which can indicate the latest serving DNS information to the EASDF. The latest serving DNS information can be the DNAI(s) for the existing PSA(s) in the PDU session, and the DNAI(s) is/are associated with the DNS message forwarding rule(s) with its DNS server information.

In step 717a-717b of FIG. 7, alternatively, not using the notification mechanism, the SMF may invoke a Neasdf_DNSContext_Update service, to update the serving DNS information to the EASDF.

In step 718 of FIG. 7, the UE sends a new DNS query message to the EASDF. In steps 719a and 720 of FIG. 7, the EASDF handles the DNS query message received from the UE according to the latest rules for handling DNS queries from the UE, the serving DNS information and the FQDN received in the DNS query message, which are similar to steps 711a, 711, and 712 of FIG. 7.

In some embodiments, the DNS configuration information can be provided to the NEF and/or stored in the NEF or the UDR either using specific procure (e.g., the exemplary procedure as described in the embodiments of FIGS. 2 and 3), or using the improved AF influenced traffic routing procedure or the improved procedure for external parameter provisioning to include the DNS configuration information (e.g., as described in the embodiments of FIG. 7). From any way the DNS configuration information is provided, the DNS configuration information can be further provided to SMF or EASDF as DNS configuration information per a node (e.g., as described in the embodiments of FIG. 2 or FIG. 5), or as DNS configuration information per PDU session (e.g., as described in the embodiments of FIG. 7 and the received DNS configuration information is used as an input for the DNS message forwarding rule).

In some embodiments, the DNS server information included in the DNS message forwarding rule or the DNS configuration information may include a list of DNS server(s) (e.g., L-DNS 1, L-DNS 2 and/or a C-DNS 1), a list of service area(s), and/or supported FQDN(s). For implementation, the DNS configuration information can be constructed per a DNS server or per a service area or per an application. The DNS configuration information constructed per a DNS server include: (1) one or more DNS servers; (2) a list of service area(s) (which may be one or more DNAIs or may be one or more identifiers different from a DNAI (e.g., a server area identifier identifying two or more DNAIs sharing the same DNS server for a DNS resolution)) for each DNS server; and/or (3) supported FQDN(s) for each DNS server. Alternatively, the DNS configuration information constructed per a service area include: (1) a list of service area(s) (which may be one or more DNAIs or may be one or more identifiers different from a DNAI (e.g., a server area identifier identifying two or more DNAIs sharing the same DNS server for a DNS resolution)); (2) one or more DNS servers for the service area; and/or (3) supported FQDN(s) for the service area. Alternatively, the DNS configuration information constructed per an application include: (1) one or more identifier(s) for application(s) (e.g. application ID(s) or FQDN(s)); (2) a list of service area(s) (which may be one or more DNAIs or may be one or more identifiers different from a DNAI (e.g., a server area identifier identifying two or more DNAIs sharing the same DNS server for a DNS resolution)); and/or (3) corresponding one or more DNS servers for the service area.

In some embodiments, the AF sends DNS configuration information for the associated EDN for any UE via a NEF. Alternatively, the AF can send DNS configuration information for the associated EDN targeting an individual UE address or a group of UEs. The AF can send the DNS configuration information of DNN/S-NSSAI and/or DNAI(s) and/or application(s) and/or the traffic identified by traffic filtering information (e.g., 5 Tuple). For example, the AF can send DNS configuration information for the associated EDN targeting an individual UE address or a group of UEs accessing the DNN/S-NSSAI per an application or per traffic identified by traffic filtering information. Depending on the AF deployment, the AF may send the AF request to PCF directly, or via the NEF. If the AF sends the AF request directly to the PCF, the AF invokes Npcf_Policy Authorization service.

FIG. 8 illustrates an exemplary block diagram of an apparatus according to some embodiments of the present application. As shown in FIG. 8, the apparatus 800 may include at least one processor 804 and at least one transceiver 802 coupled to the processor 804. The apparatus 800 may be a network function of a network (e.g., an EASDF or a SMF as illustrated and shown in any of FIGS. 1B, 1C, and 2-7).

Although in this figure, elements such as the at least one transceiver 802 and processor 804 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be an EASDF of a network. The transceiver 802 may be configured to receive serving DNS information from a further network function of the network. The processor 804 may be configured to select a DNS server or an ECS option for a FQDN originating from a UE the serving DNS information. The DNS server or the ECS option is selected based on: (a) the serving DNS information; and (b) “DNS configuration information of the network” and/or “one or more rules for handling DNS information”.

In some embodiments of the present application, the apparatus 800 may be a SMF of a network. The transceiver 802 may be configured to receive DNS configuration information of the network. The transceiver 802 may be further configured to transmit: (a) the serving DNS information; and the (b) “the DNS configuration information of the network” and/or “one or more rules for handling DNS information”, so as to select a DNS server or an ECS option for a FQDN originating from a UE.

In some embodiments of the present application, the apparatus 800 may further include at least one non-transitory computer-readable medium. In some embodiments of the present disclosure, the non-transitory computer-readable medium may have stored thereon computer-executable instructions to cause a processor to implement the method with respect to the network function(s) as described above. For example, the computer-executable instructions, when executed, cause the processor 804 interacting with transceiver 802, so as to perform operations of the methods, e.g., as described in view of any of FIGS. 1B, 1C, and 2-7.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

1. A method performed by a first network function of a network, the method comprising:
receiving serving domain name service (DNS) information from a second network function of the network; and
selecting one of a DNS server or an extension for DNS client subnet (ECS) option for a fully qualified domain name (FQDN) originating from a user equipment (UE), wherein the selected one of the DNS server or the ECS option is selected based on:
(a) the serving DNS information; and
(b) at least one of DNS configuration information of the network and one or more rules for handling DNS information.

2. The method of claim 1, wherein the serving DNS information is included in at least one of:
a notification indicating a change of the serving DNS information from the second network function;
a message associated with a DNS context create procedure; and
a message associated with a DNS context update procedure.

3. The method of claim 1, wherein the serving DNS information is used for indicating a condition for selecting the DNS server or a condition for handling DNS information and the serving DNS information includes at least one of:
a list of one or more data network access identifiers (DNAIs);
an identifier for identifying a service area of a serving DNS server; and
an ECS option for handling the DNS information.

4. (canceled)

5. The method of claim 1, wherein the one or more rules for handling DNS information includes at least one of:
a DNS information reporting rule; and
a DNS information forwarding rule, wherein the DNS information forwarding rule includes at least one of:
one or more ECS options for handling the DNS information; and
information relating to one or more DNS servers, the information including at least one of:
a list of one or more DNS servers;
a list of one or more service areas; and
a list of one or more supported FQDNs.

6. The method of claim 1, further comprising:
receiving the DNS configuration information on a per network function basis via a DNS configuration management procedure from at least one of:
a session management function (SMF); and
a network exposure function (NEF).

7. The method of claim 1, wherein the DNS configuration information includes at least one of:
a list of one or more DNS servers;
a list of one or more service areas; and
a list of one or more supported FQDNs.

8. The method of claim 1, further comprising:
buffering a received DNS query message; and
waiting for updated information relating to at least one of: DNS configuration information of the network; one or more rules for handling DNS information; and the serving DNS information.

9. (canceled)

10. The method of claim 1, wherein:
if the DNS server is associated with the FQDN in a received DNS query message, the method further comprises forwarding the received DNS query message to the selected DNS server; and
if the ECS option is associated with the FQDN in a received DNS query message, the method further comprises forwarding the received DNS query message with the selected ECS option.

11.-13. (canceled)

14. An apparatus providing a first network function, the apparatus comprising:
a processor; and
a wireless transceiver coupled to the processor, wherein the processor is configured to:
receive, via the wireless transceiver, serving domain name service (DNS) information from a second network function of the network; and
select a DNS server or an extension for DNS client subnet (ECS) option for a fully qualified domain name (FQDN) originating from a user equipment (UE), wherein the DNS server or the ECS option is selected based on:
(a) the serving DNS information; and
(b) at least one of DNS configuration information of the network and one or more rules for handling DNS information.

15. (canceled)

16. The apparatus of claim 14, wherein the serving DNS information is included in at least one of:
a notification indicating a change of the serving DNS information from the second network function;
a message associated with a DNS context create procedure; and
a message associated with a DNS context update procedure.

17. The apparatus of claim 14, wherein the serving DNS information is used for indicating one of a condition for selecting the DNS server or a condition for handling DNS information and the serving DNS information includes at least one of:
a list of one or more data network access identifiers (DNAIs);
an identifier for identifying a service area of a serving DNS server; and
an ECS option for handling the DNS information.

18. The apparatus of claim 14, wherein the one or more rules for handling DNS information includes at least one of:
a DNS information reporting rule; and
a DNS information forwarding rule, wherein the DNS information forwarding rule includes at least one of:
one or more ECS options for handling the DNS information; and
information relating to one or more DNS servers, the information including at least one of:
a list of one or more DNS servers;
a list of one or more service areas; and
a list of one or more supported FQDNs.

19. The apparatus of claim 14, wherein the processor is further configured to:
receive the DNS configuration information on a per network function basis via a DNS configuration management procedure from at least one of:
a session management function (SMF); and
a network exposure function (NEF).

20. The apparatus of claim 14, wherein the DNS configuration information includes at least one of:
a list of one or more DNS servers;
a list of one or more service areas; and
a list of one or more supported FQDNs.

21. The apparatus of claim 14, wherein the processor is further configured to:
buffer a received DNS query message; and
wait for updated information relating to at least one of: DNS configuration information of the network; one or more rules for handling DNS information; and the serving DNS information.

22. The apparatus of claim 14, wherein the ECS option is associated with a PDU session anchor (PSA) for the FQDN in a received DNS query message.

23. The apparatus of claim 14, wherein:
the DNS server is associated with the FQDN in a received DNS query message; and
the processor is further configured to forward the received DNS query message to the selected DNS server.

24. The apparatus of claim 14, wherein:
the ECS option is associated with the FQDN in a received DNS query message; and
the processor is further configured to forward the received DNS query message with the selected ECS option.

25. An apparatus providing a first network function of a network, the apparatus comprising:
a processor; and
a wireless transceiver coupled to the processor, wherein the processor is configured to:
receive, via the wireless transceiver, domain name service (DNS) configuration information of the network; and
transmit, via the wireless transceiver;
(a) serving DNS information; and
(b) at least one of: the DNS configuration information of the network; and
one or more rules for handling DNS information, in order to select a DNS server or an extension for DNS client subnet (ECS) option for a fully qualified domain name (FQDN) originating from a user equipment (UE).

26. The apparatus of claim 12, wherein to receive the DNS configuration information the processor:
receives the DNS configuration information via a DNS configuration management procedure from a network exposure function (NEF) of the network.
